(19) United States
(12) Patent Application Publication
(10) Pub. No.: US 2001/0026594 A1
(43) Pub. Date: Oct. 4, 2001

(54) Method for encoding a stream of bits of a binary source signal into a stream of bits of a binary channel signal

(76) Inventor: Marten Erik Van Dijk, Eindhoven (NL)

Correspondence Address: Corporate Patent Counsel, U.S. Philips Corporation, 580 White Plains Road, Tarrytown, NY, 10591, US

(21) Appl. No.: 09/817,096

(22) Filed: Mar. 26, 2001

(30) Foreign Application Priority Data
Mar. 30, 2000 (EP) 00201143.5

(51) Int. Cl. H04L 25/34

(52) U.S. Cl. 375/286; 714/810

(57) ABSTRACT

The invention relates to a method for encoding a stream of bits of a signal relating to a binary source into a stream of bits of a signal relating to a binary channel, the binary source comprising a main source and a secondary source, the main source being encoded in a main channel by multi-level coding and the secondary source being encoded in a secondary channel, the secondary channel being embedded in the main channel in order to form the binary channel, wherein the secondary channel is divided in at least a first section comprising user data and a second section comprising non user data.

The invention further relates to an encoder to carry out this method, a decoder to decode the stream of bits relating to the binary channel and a record carrier provided with the encoded signal in the form of optically detectable marks.

By means of the invention copy protection can be improved.

The invention relates to a method for encoding a stream of bits of a signal relating to a binary source into a stream of bits of a signal relating to a binary channel, the binary source comprising a main source and a secondary source, the main source being encoded in a main channel and the secondary source being encoded in a secondary channel, the secondary channel being embedded in the main channel by means of limited multi-level coding in order to form the binary channel.

The invention also relates to an encoder for carrying out this method comprising an input for receiving a stream of bits of a signal relating to a binary source and an output for providing a stream of bits of a signal relating to a binary channel, the binary source comprising a main source and a secondary source, the encoder comprising means for encoding the main source in a main channel; means for encoding the secondary source in a secondary channel, and means for embedding the secondary channel in the main channel by means of multi-level coding in order to form the binary channel.

The invention also relates to a method for decoding a stream of bits of a signal relating to a binary channel into a stream of bits of a signal relating to a binary source, the binary channel comprising a main channel and a secondary channel, the secondary channel being embedded in the main channel via multi-level coding, and a stream of corrected bits of the binary channel relating to the main channel being used for correcting errors in the stream of bits of the binary channel relating to the secondary channel.

Further the invention relates to a device for decoding a stream of bits of a signal relating to a binary channel into a stream of bits of a signal relating to a binary source, which device comprises decoding means conceived to decode a main channel, the decoding means being also conceived to decode a secondary channel, the secondary channel being embedded in the main channel, by means of multi-level coding, and to correct errors in the stream of bits of the binary channel relating to the secondary channel using a stream of corrected bits of the binary channel relating to the main channel.

The invention also relates to a record carrier of the optical readable type in which the information has been recorded as a pattern of optically detectable marks arranged along the track.

The invention is applicable on information carriers with different kinds of channels codes. The information stored on these information carriers can, for example, be coded according to a runlength-limited (RLL) code. A RLL code is characterized by two parameters, (d+1) and (k+1), which stipulate the minimum and maximum runlength, respectively, that may occur in the code. For example, different DVD-formats, like DVD-RAM, DVD+RW or DVD-RW use a (d=2, k=10) RLL EFM⁺ code.

The basic functioning of a method and a device for en/decoding a stream of bits of a binary source signal into a stream of bits of a binary channel signal and vice versa can be understood from UK Patent Application GB 2 083 322 (PHQ 80007). In this case, the binary channel signal to be en/decoded is runlength limited. The stream of bits of a binary channel is obtained by reading out an information carrier with a focused laser beam, as is typical for optical information carriers. Using these RLL code and these reading out technique results in information carriers with a reasonable high capacity.

Under the conditions of the beam spot diameter (depending on the NA of the objective lens used) and the wavelength of the present laser beam, the capacity of the information carrier however can not be increased when keeping identical detection margins.

The non-published European patent application, no. 99200873.0 (PHN 17.369 EP-P) describes a method to increase the capacity of the information carrier by addition of a secondary channel on top of a main channel. The main channel is a binary channel where pits and non-pits (lands) are related to two possible signal levels (below and above a threshold level).

In this earlier described method the binary channel comprises a main channel and a secondary channel, the secondary channel being embedded in the main channel via multi-level coding. A stream of corrected bits of the binary channel relating to the main channel after decoding and error correction is re-encoded and used for correcting errors in the stream of bits of the binary channel relating to the secondary channel.

When establishing this interaction between error correction of the main channel and error correction of the secondary channel, a reliable secondary channel is created. It must be noted that the secondary channel exists by the grace of the main channel due to its hierarchical structure. Multi-level coding can be achieved in different ways. A physical parameter of the secondary channel can be used for multi-level coding, e.g. a so-called “peanut”-structure can be made, the depth and/or width of the pits and marks can be varied.

In the case of multi-level coding, this coding is applied for runlengths Inₘᵢₙ or greater, in which nₘᵢₙ is a predetermined value, for example nₘᵢₙ=6. Apart from the main channel, which carries information in the occurrence of runlengths, extra capacity then is available in the amplitude level of longer runlengths (the secondary channel). The secondary channel is hierarchically dependent on the main channel, since bits relating to this secondary channel can only be accommodated at those locations in the channel bit stream, where the main channel coding uses longer runlengths. This secondary channel is realized via limited multi-level (LML) coding. The limitation consists of the choice that multi-level coding is only applied for runlengths Inₘᵢₙ or greater, in which nₘᵢₙ is a predetermined integer.

By using LML coding for a secondary channel, for enough for nₘᵢₙ=6 an extra capacity for user date of more than 10% can be obtained. Already many attempts have been made to prevent unauthorized copying of information carriers of the present type, but none of these up-to-now appeared to be fully satisfactory.

The object of the invention is to improve the copy protection of an information carrier of the present type. According to the invention the secondary channel is divided in at least a first section comprising user data and a-second section comprising non-user data, such as authenticity data.

The present invention is based on the insight that the principle of LML coding also can be used advantageously for the copy protection of CD's.

The device according to the invention comprises means to detect possible errors in the second section and to provide a signal when the number of these errors exceeds a predetermined number.

According to a preferred embodiment of the invention the second section of the secondary channel is the lead-in section of the information carrier and the authenticity data are registered by means of multi-level coding of runlengths all having a predetermined length In. For example, the runlength in the lead-in section can be n=7.

By using fixed runlengths in the lead-in section, data only can be stored in the lead-in section by means of multi-level coding. The fixed runlength either is a conventional land or a level coded land, also called a peanut land, or a conventional pit or a level coded pit, a peanut pit.

In each runlength therefore, one bit of secondary channel information can be stored. The lead-in section of a CD is large enough to contain enough fixed runlengths in order to be able to encode both the conventional lead-in information, such as duration of the program on the CD, duration of the tracks etc. as well as authenticity information in the form of an encoded authenticity i.c. copyright data.

The advantage of the invention is that the LML coded secondary channel is very difficult to copy.

It is observed that in EP-A-0 545 472 a system is disclosed for the copy protection of a CD by means of storing a code in the lead-in part of a CD track. In this prior art a storing takes place by means of modulating a secondary channel. In this prior art however, the secondary channel is formed by a physical wobble in the lead-in track.

The encoder according to the invention comprises means for dividing the secondary channel in at least a first section comprising user data and a second section comprising non user data.

The method for decoding according to the invention is suitable for decoding a stream of bits relating to a binary channel that is encoded in accordance with the method according to the invention.

By using erasure information from the main channel when correcting errors in the stream of bits of the binary channel relating to the secondary channel, the traditional error correction of the secondary channel (before referred to as the second stage of error correction for the secondary channel) can be improved. Erasure information is information indicating the presence of possible errors in the bit stream and is generated during the error correction of the main channel. The number of errors which can be corrected by the second stage of error correction for the secondary channel is increased using this erasure information.

The device in accordance with the invention is characterized in that said decoding means are also conceived to decode non-user bits in the secondary channel.

Another device in accordance with the invention is characterized in that the device further comprises reading means for reading out an information carrier to obtain the stream of bits of the binary channel signal.

In the record carrier according to the invention the detectable marks comprise main channel bits and secondary channel bits, which are embedded in the main channel bits, the secondary channel bits comprising at least a first section comprising user data and a second section comprising non user data.

The invention will be further described in the following figure description in which

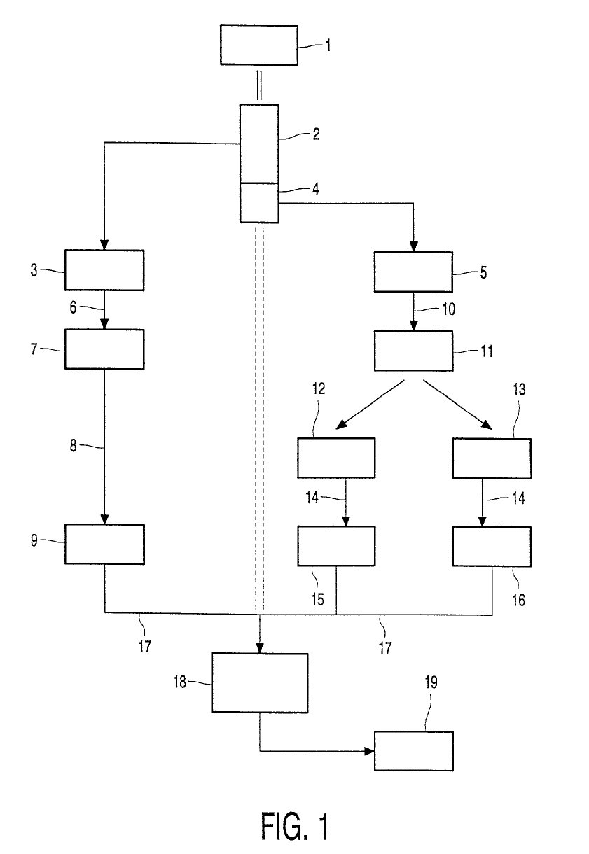

FIG. 1 shows a first embodiment of a method for encoding

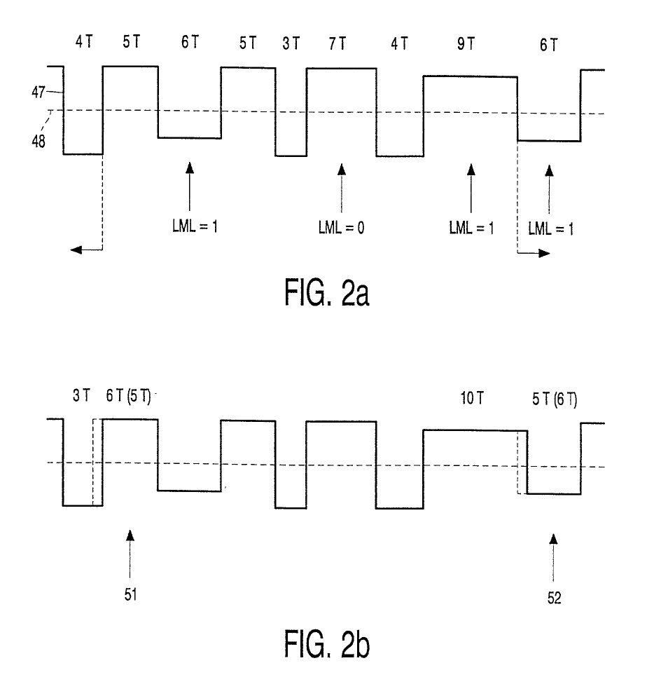

FIG. 2a, b shows the presence and origin of bit slips in the secondary channel,

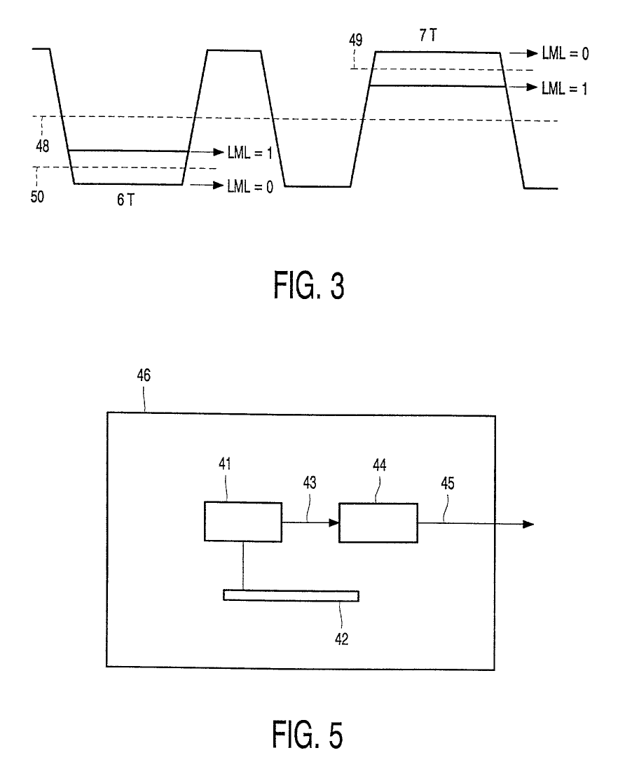

FIG. 3 shows an embodiment of the detection of the secondary channel,

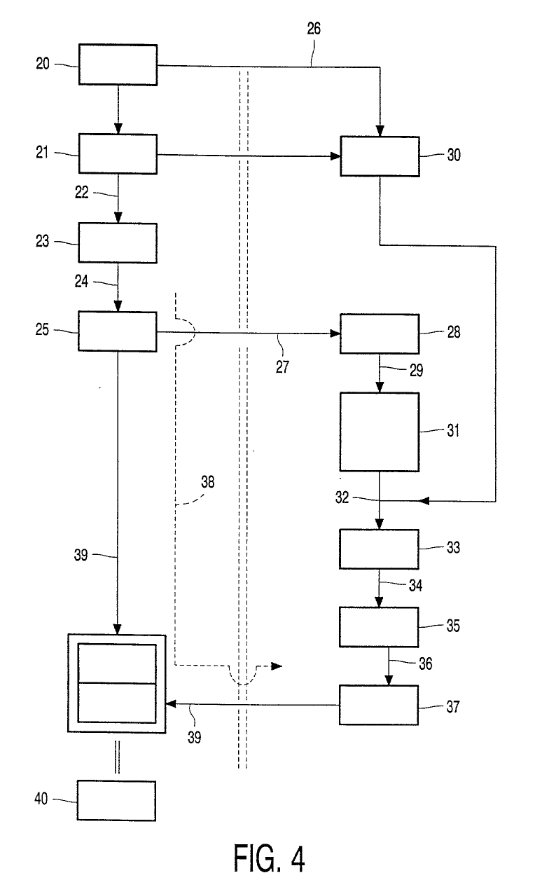

FIG. 4 shows an embodiment of a method for decoding according to the invention, and

FIG. 5 shows an embodiment of a device for decoding according to the invention.

FIG. 1 shows an embodiment of a method for encoding according to the aforementioned proposal (PHN 17369 EP-P). User data 1 is partitioned between the main channel 2, comprising main user bits 3, and the secondary channel 4, comprising secondary user bits 5. In step 6, error-correction is applied on the main user bits 3, yielding main source bits 7. These main source bits 7 comprise of user data and parities generated in step 6. In step 8, encoding of the main source bits 7 yields the main channel bits 9 without the amplitude information. The encoding in step 8 can for example be accomplished via a standard RLL channel code, e.g. EFM⁺, well known to a person skilled in the art.

In step 10, error-correction is applied on the secondary user bits 5, yielding secondary source bits 11. These secondary source bits 11 comprise of user data and parities generated in step 10. The secondary source bits 11 are further split into a secondary pit channel 12, with secondary pit bits and an secondary land channel 13, with secondary land bits. In step 14, a d=0 DC-free channel code is used for encoding both channels to generate secondary pit channel bits 15 and secondary land channel bits 16. An example of such a d=0 channel code is the 8-to-9 d=0 code as can be found in U.S. Pat. No. 5,642,113 (PHN 14789). The DC-free property of the code used for encoding is needed in order to retrieve (during the secondary channel detection) the slicer level from the measured waveform for detection of the secondary bits.

The secondary channel bits yield the amplitude information to be incorporated into the waveform that is to be generated from the secondary channel bit stream. In step 17, the main channel bits 9, the secondary pit channel bits 15 and the secondary land channel bits 16 are combined into the assembled channel bits 18. These assembled channel bits 18 are then written on an information carrier 19.

When writing the assembled channel bits on the information carrier the multilevel coding is only applied for runlengths In-min or greater, in which In-min is a predetermined value. This multi-level coding can be performed in different ways. For example, the pits and lands can be mastered in a so-called “peanut”-structure which is realized by turning off the laser at a predetermined place and for a predetermined time in case of a pit and by turning on the laser at a predetermined place and for a predetermined time in case of a land. Also a narrower pit structure can be used for multi-level coding. The method according to the invention is not limited to multi-level coding of a particular kind; In the present embodiment limited multi-level coding is used, but the method according to the invention is not limited to this so-called limited-level coding.

The secondary channel 4 is dependent on the main channel 2 due to the linking of the secondary amplitude-effect with the longer runlengths. The detection problem caused by the hierarchy between main and secondary channels will be explained for the case In-min=6. Suppose for instance that a channel error occurred in the main channel (a simple transition shift) which turned an I5 into an I6. The first run does not carry an additional bit whereas the second one does. Therefore, straightforward detection of the secondary channel yields a bit-insertion. A bit-deletion takes place when an I6 is turned into an I5 during RLL detection. In fact, simple transition shifts in the RLL channel can lead to bit slips (bit insertions and bit deletions) in the LML channel. This is further explained with reference to FIG. 2.

FIG. 2 shows the presence and origin of bit slips in the secondary channel. In FIG. 2a an original RLL sequence 47 is shown with runlengths 4T, 5T, 6T, 5T, 3T, 7T, 4T, 9T and 6T, as is indicated in this Figure above the sequence 47. The dashed line 48 indicates the normal slicer level used for detection of the main channel. With LML=0 and LML=1 under the sequence 47 is indicated what sort of secondary/LML-source bit is present is the indicated runlength. The meaning of LML=0 and LML=1 is explained using FIG. 3.

FIG. 3 shows an embodiment of the detection of the secondary channel. Secondary channel-detection is performed on the basis of the signal waveform and checks via a slicer operating on the amplitude e.g. in the middle of the run if runs have the secondary channel amplitude-effect or not. One stores the information of the secondary channel-effect on all runs on a symbol-by-symbol basis (for symbols of length equal to n channel bits). One could also decide just to store this information for all runs ranging from an I(n-min-1) and larger, in case single-bit transition shifts are the main error source in the main channel. The storage on a symbol-by-symbol basis is needed in order to avoid problems with missing runs in the main channel, i.e. short runlengths of which the signal waveform does not reach beyond the slicer level of the main channel, which can occur with low probability.

For runlengths 6T and 7T it is indicated how the detection of the secondary/LML bits is done. The dashed line 49 indicates the LML-land slicer level used for detection of the secondary/LML-land bits. The dashed line 50 indicates the LML-pit slicer level used for detection of the secondary/LML-pit bits. Depending on the detection with these slicer levels 49 and 50, the character of the LML-bit is indicated with LML=0 or LML=1. The slicer levels 49 and 50 are used to decide whether runs have the secondary channel amplitude-effect or not.

In FIG. 2b the principle behind LML-bit insertion and LML-bit deletion is shown. Arrow 51 indicates the presence of LML-bit insertion as the original runlength 5T from FIG. 2a is detected as a 6T runlength. In this case a bit-insertion takes place when an I5 is turned into an I6 during RLL detection if for the parameter n-min is n-min=6. Arrow 52 indicates the presence of LML-bit deletion as the original runlength 6T from FIG. 2a is detected as a 5T runlength. In this case a bit-deletion takes place when an I6 is turned into an I5 during RLL detection if for the parameter n-min is n-min=6.

The solution to the above problem of bitslips is described in FIG. 4. It shows an embodiment of a method for decoding according to the invention. The main channel bits are detected out of the signal waveform 20. The method for decoding the main channel bits into the main user bits is just the standard one, well-known to a person skilled in the art: in step 22 the main channel bits 21 are decoded into the main source bits 23, in step 24 the error-correction is applied on the main source bits 23, which yields the corrected main source bits 25. These corrected main source bits 25 comprise user data plus parities.

In this embodiment of a method for decoding according to the invention the detection of the secondary channel requires the following: In step 26 secondary channel detection is accomplished. During the detection of the main channel, channel errors may lead to erroneous runlengths in the main channel bit stream, i.e. detected runlengths may be different from encoded runlengths. Therefore, one assumes first that each runlength carries a potential secondary channel bit, and secondary channel detection is performed on each runlength. Notice that only if the encoded runlength is equal to or larger than In-min, then an actual secondary channel bit is detected. In step 26, secondary channel detection is performed on the basis of the signal waveform and checks via a slicer operating on the amplitude in the middle of the run if runs have the secondary channel amplitude-effect or not (i.e. if a potential LML bit has value 1 or 0). One stores the information of the secondary channel effect on all runs on a symbol-by-symbol basis in block 30. One could also decide just to store this information for all runs ranging from an I(n-min-1) and larger, in case single-bit transition shifts are the main error source in the main channel. The storage on a symbol-by-symbol basis is needed in order to avoid problems with missing runs, i.e. short runlengths of which the signal waveform does not reach beyond the slicer level of the main channel.

After error-correction of the main channel in step 24, in step 27 the corrected main source bits 25 are re-encoded yielding the exact main channel bit stream 28. In step 29, this exact main channel bit stream 28 is used to yield the correct position of all runs in the main channel bit stream and is shown in block 31. In step 32, this exact knowledge of the occurrence of the long runlengths, stored in block 31, is combined with the secondary channel info about potential secondary channel bits, stored in block 30, which yields the detected secondary channel bits 33. In step 34, decoding of the secondary channel yields the secondary channel user bits 35. In step 36, traditional error-correction of the secondary channel finally yields the corrected secondary channel user bits 37. In step 39, the secondary channel user data 37 are combined with the user data of the main channel 25 (i.e. the corrected main source bits), to reassemble the complete user data 40. Also in this step 39 the parities are removed.

The embodiment as described above is to be considered as one example to which the method of decoding according to the invention is applicable. The error-correction of the secondary channel (step 36) can be improved via information generated during the error-correction of the main channel (step 24). This is indicated by the dashed line 38. E.g. information about burst-errors generated from the main channel error-correction can be used as erasure information for the error-correction of the secondary channel.

In the foregoing the paragraph of LML coding has been explained. According to the present invention in the lead-in track of the information carrier the data in block 1 of FIG. 1 are lead-in data, this data is organized in such a way that all RLL bits 3 have a final runlength In, with for example n=7. This means that in the main channel no information can be stored. The secondary channel bits 5 in the lead-in channel are used to store encoded copyright data and conventional lead-in data. The lead-in track has enough capacity to store both types of information. During the decoding process the number of errors in the decoded copyright data are determined. When the number of errors exceeds a certain level, a signal is provided that for example can block further decoding.

FIG. 5 shows an embodiment of a device 46 for decoding according to the invention. The device comprises reading means 41 for reading out an information carrier 42, e.g. a DVD-ROM. These reading means 41 comprise an optical system for generating a focussed light spot on the information carrier 42 and a detector for detecting the reflected light spot. The reading means 41 produce a stream of bits of a signal relating to a binary channel 43. This stream of bits of a signal relating to a binary channel 43 is decoded in a decoder 44 into a stream of bits of a signal relating to a binary source 45. The decoder 44 comprises standard means for decoding a RLL channel code, e.g. (EFM⁺)⁻¹ and means for error-correction, e.g. CIRC-correction, both well known to a person skilled in the art. The decoder 44 further comprises means for decoding a secondary channel according to the method according to the invention. The stream of bits of a signal relating to a binary source 45 is outputted by the device 46 and can be further processed, e.g. for playing audio information, for screening video information.

Whilst the invention has been described with reference to preferred embodiments thereof, it is to be understood that these are not limitative examples. Thus, various modifications may become apparent to those skilled in the art, without departing from the scope of the invention, as defined in the claims.

One of the possible modifications is when the main channel is not used and functions only as a carrier for the secondary channel. In such a situation, during decoding, the steps 20-25; 27-32 and 38-40 are superfluous because the steps 26, 30 and 32 can be combined to realize step 33. This is true because the pit-land structure on the main channel is known beforehand. During reading step 26, step 33 can be realized immediately. The steps 39 and 40 are superfluous because there is nothing to combine.

Further, the invention lies in each and every novel feature or combination of features.

1. A method for encoding a stream of bits of a signal relating to a binary source into a stream of bits of a signal relating to a binary channel, the binary source comprising a main source and a secondary source, the main source being encoded in a main channel by multi-level coding and the secondary source being encoded in a secondary channel, the secondary channel being embedded in the main channel in order to form the binary channel, characterized in that the secondary channel is divided in at least a first section comprising user data and a second section comprising non user data.

2. Method according to claim 1, wherein the second section comprises the lead-in section of the stream of bits of the signal relating to the secondary source.

3. Method according to claim 1 or 2 wherein the signal related to the main source is encoded in runlengths all having the same length In.

4. Method according to claim 3, wherein In=7.

5. Method according to any of the claims 1-4, wherein the non user data are authenticity data.

6. An encoder comprising an input for receiving a stream of bits of a signal relating to a binary source and an output for providing a stream of bits of a signal relating to a binary channel, the binary source comprising a main source and a secondary source, the encoder comprising means for encoding the main source in a main channel; means for encoding the secondary source in a secondary channel, and means for embedding the secondary channel in the main channel by means of multi-level coding in order to form the binary channel, wherein means are provided for dividing the secondary channel in at least a first section comprising user data and a second section comprising non user data.

7. Encoder according to claim 6, wherein the second section comprises the lead-in section of the stream of bits of the signal relating to the secondary source.

8. Encoder according to claim 6 or 7 wherein the signal related to the main source is encoded in runlengths all having the same length In.

9. Method for decoding a stream of bits of a signal relating to a binary channel into a stream of bits of a signal relating to a binary source, the binary channel comprising a main channel and a secondary channel, the secondary channel being embedded in the main channel via multi-level coding, and a stream of corrected bits of the binary channel relating to the main channel being used for correcting errors in the stream of bits of the binary channel relating to the secondary channel, wherein the stream of bits of the signal relating to the binary channel is encoded in accordance with the method of any of the claims 1-5.

10. A device for decoding a stream of bits of a signal relating to a binary channel into a stream of bits of a signal relating to a binary source, which device comprises decoding means conceived to decode a main channel, the decoding means being also conceived to decode a secondary channel, the secondary channel being embedded in the main channel, and to correct errors in the stream of bits of the binary channel relating to the secondary channel using a stream of corrected bits of the binary channel relating to the main channel, wherein said decoding means further are conceived to decode non-user bits in the secondary channel.

11. A device according to claim 10, wherein the device further comprises reading means for reading out an information carrier to obtain the stream of bits of the binary channel signal.

12. A device according to claim 10, wherein the non user bits comprise authenticity data and means are provided to detect errors in the decoded non user data and to provide a signal when the number of errors exceeds a predetermined value.

13. A record carrier of the optical readable type in which the information has been recorded as a pattern of optically detectable marks arranged along a track, wherein the detectable marks comprise main channel bits and secondary channel bits, which are embedded in the main channel bits, the secondary channel bits comprising at least a first section comprising user data and a second section comprising non user data.

14. A record carrier according to claim 13, wherein the second section comprises the lead-in section of the stream of bits of a signal relating to a secondary source that has been encoded into the secondary channel.
